(19) United States
(12) Patent Application Publication
(10) Pub. No.: US 2018/0306756 A1
(43) Pub. Date: Oct. 25, 2018

(54) METHOD FOR CHECKING COMPLETENESS

(71) Applicant: Pepperl+Fuchs GmbH, Mannheim (DE)

(72) Inventor: Till STEINER, Mannheim (DE)

(73) Assignee: Pepperl+Fuchs GmbH, Mannheim (DE)

(21) Appl. No.: 15/957,112

(22) Filed: Apr. 19, 2018

(30) Foreign Application Priority Data
Apr. 21, 2017 (DE) 10 2017 108 501.7

(51) Int. Cl. G01N 29/44; B07C 5/34; G06T 7/00

(52) U.S. Cl. CPC G01N 29/4418; G06T 2207/10132; G06T 7/001; B07C 5/34

(57) ABSTRACT

A method for checking completeness, in a first step, passes a first object to a measuring station, wherein the measuring station has at least one ultrasonic sensor that is fixed in place, and in a second step, measures the first object using ultrasound, wherein an image of the object is created by an artificial intelligence. In a third step, the artificial intelligence compares the image obtained with a reference image, wherein the reference image is derived from a predetermined, complete object.

### CROSS REFERENCE TO RELATED APPLICATIONS

Applicant claims priority under 35 U.S.C. § 119 of German Application No. 10 2017 108 501.7 filed Apr. 21, 2017, the disclosure of which is incorporated by reference.

### BACKGROUND OF THE INVENTION

### 1. Field of the Invention

The invention relates to a method for checking completeness of objects.

### 2. Description of the Related Art

Methods for checking completeness serve for quality assurance. In this regard, a check is undertaken as to whether all the integral parts required for a process to take place properly are present. In general, this check of completeness is a check of presence, in which it is checked whether all the integral parts of an object, for example of a component or of a module, are present at the correct location. In this regard, the object is recorded using multiple cameras or color sensors, for example. Subsequently, an image of the object is created by means of image processing methods, and it is checked whether this image agrees with a predetermined image of a complete object.

Computers having great computing power are required for such image processing methods.

### SUMMARY OF THE INVENTION

It is therefore an object of the present invention to make available a method for checking completeness, in which computers can be used that possess only very low computing power.

These and other objects are accomplished in accordance with the invention.

Therefore the invention relates to a method for checking completeness, which method comprises multiple consecutive steps. In a first step, a first object is passed to a measuring station, wherein the measuring station has at least one ultrasonic sensor that is fixed in place. If a more precise image of the object is supposed to be obtained, the measuring station can also contain more than just one ultrasonic sensor, for example 2 to 8 ultrasonic sensors.

Subsequently, in a second step, the first object is measured by means of the ultrasonic sensors in the measuring station, wherein signals are obtained that are made available to an artificial intelligence for further processing. This artificial intelligence creates an image of the object from these signals. This artificial intelligence can be implemented on a computer, for example; this computer can be a simple personal computer (PC), for example.

Finally, in a third step, the artificial intelligence compares the image of the object that was obtained with a reference image, wherein the reference image has been derived from at least one predetermined object. This predetermined object is, for example, a complete object, in other words an object that has all the required integral parts, but not any unnecessary parts. Optionally, in order to improve the reference image, derivations of incomplete objects can also be used in addition.

This method is advantageous in that the artificial intelligence creates an image of the object from the ultrasonic sensor data, which image can be compared with the reference image easily and quickly, without this artificial intelligence having to demonstrate great computing power. For this reason, even a PC or microcontroller can be used as the artificial intelligence.

In an advantageous embodiment, a second object is passed to the measuring station as soon as the first object has been measured. In this way, multiple objects, for example, can be made available, one after the other, on a transport apparatus, for example a conveyor belt, which transports the objects in the direction of the measuring station. As soon as an object has been measured, it is moved out of the measuring station again, and an object situated behind it is moved into the measuring station and measured there.

After the first object has been removed and the subsequent second object to be measured has been passed to the measuring station, the second object is measured using ultrasound. The signals obtained are passed on to an artificial intelligence. From these signals, the artificial intelligence creates an image of the object. In a further step, the artificial intelligence compares the image obtained with the reference image.

In a further preferred embodiment, in a fourth step, in other words after the object has been removed from the measuring station, this object is sorted out if the image obtained does not agree with the reference image. If the image obtained for the object does agree with the reference image, then the object is transported to a further station. This station can be a packaging station in which the object is packaged. This station can also be a processing station in which the object is processed further.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1a shows a schematic representation of a predetermined, complete object;

FIG. 1b shows a schematic representation of an object to be measured;

FIG. 2 shows a perspective view of a measuring station in which objects can be measured;

FIG. 3 shows a section A-A through the measuring station shown in FIG. 2;

FIG. 4 shows inner workings of the measuring station shown in FIG. 2;

FIG. 5 shows inner workings of a variant of the measuring station shown in FIG. 4;

FIG. 6 shows a further variant of a measuring station; and

FIG. 7 shows an underside of the measuring station shown in FIG. 6.

### DETAILED DESCRIPTION OF PREFERRED EMBODIMENTS

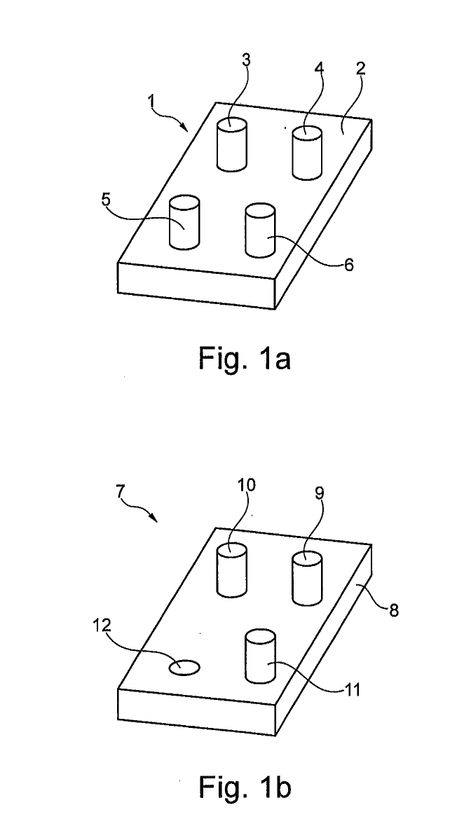

FIG. 1a shows a schematic representation of a predetermined object 1, i.e. of an object that is complete. This object 1 comprises a basic body 2, in which four similar components 3 to 6 are disposed. This object 1 is measured by means of ultrasound, so that an image of this object 1 is obtained.

For this purpose, alternating voltage is applied to an ultrasonic transducer of an ultrasonic sensor, wherein the transducer preferably is a piezoelectric quartz or ceramic oscillator. The ultrasonic transducer is not shown, however, in FIG. 1a. The transducer is excited by means of the application of the alternating voltage so as to produce oscillations, so that ultrasonic waves are formed. These ultrasonic waves emitted by the ultrasonic sensor impact the object 1 and in turn are reflected by this object 1. These reflected ultrasonic waves can in turn be received by the ultrasonic transducer. The electrical signals obtained as a result are subjected to pre-processing of an evaluation of frequency, phase or amplitude. Subsequently, the evaluation result is passed to an artificial intelligence, so that finally, an image of the object 1 is obtained. This image of the object 1 is used as a reference image. This reference image can then be compared with the images of other objects that also have been measured by means of ultrasound. Because ultrasonic measurements are known as such, these measurements will not be discussed in any further detail.

In FIG. 1b, a schematic representation of an object 7 to be measured is shown. This object 7 also has a basic body 8 in which multiple components 9 to 11 are disposed. In this basic body 8, however, not four but rather only three components 9 to 11 are disposed, so that one component is missing and a gap 12 is formed. This object 7 is therefore not complete. If this object 7 is measured by means of ultrasound, an image is also obtained. This image is compared with the reference image. By means of the comparison of the recorded image with the reference image, it can therefore be determined that the object 7 is not complete. The incomplete object 7 can therefore be detected very easily and quickly, and can ultimately be sorted out or corrected. In this way, incomplete objects are prevented from being processed further, or—if these objects are end products—incomplete objects are prevented from leaving a production operation.

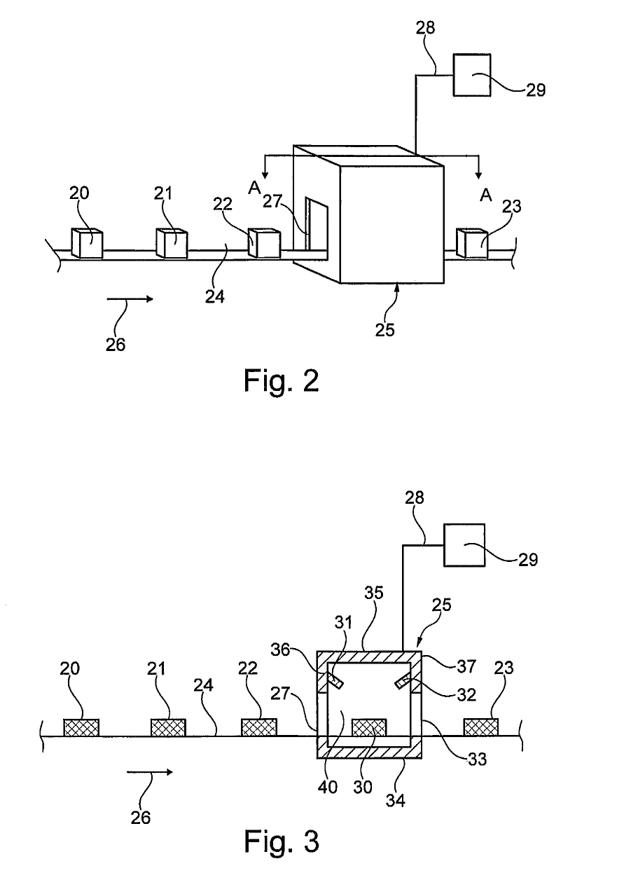

FIG. 2 shows a perspective view of multiple objects 20 to 23, which are disposed on a transport apparatus 24. The transport apparatus 24 shown in FIG. 2 is a conveyor belt, wherein only parts of the transport apparatus 24 are shown. In this regard, the objects 20 to 23 are transported in the direction of an arrow 26 and get into a measuring station 25 by way of an opening 27. In this measuring station 25, the objects are measured by means of ultrasonic sensors. The ultrasonic sensors are situated within the measuring station 25, however, and for this reason these ultrasonic sensors cannot be seen in FIG. 2. The objects are transported out of the measuring station 25 once again by means of the transport apparatus 24, through an opening that cannot be seen in FIG. 2, which lies opposite the opening 27. For this reason, the object 23 has already left the measuring station 25. In the measuring station 25, there is also an object that is just being measured, but cannot be seen in FIG. 2.

The measuring station 25 is connected with an artificial intelligence 29, preferably a computer, by way of at least one line 28. The artificial intelligence 29 as well as the at least one line 28 are shown only schematically. If multiple lines are provided, then this connection can also be a line run. In this artificial intelligence 29, the electrical signals obtained from the ultrasonic sensors are subjected to an evaluation of frequency, phase or amplitude, so that ultimately, an image of the object that is just being measured is obtained.

FIG. 3 shows a section A-A through the measuring station 25 shown in FIG. 2, wherein the section was also passed through the transport apparatus 24 as well as through the objects 20 to 23 disposed on it. The measuring station 25 is connected with an artificial intelligence 29 by way of at least one line 28.

The transport apparatus 24 is conducted through the measuring station 25 in the direction of the arrow 26. In this regard, the objects 20 to 22 situated on the transport apparatus 24 can get into the measuring station 25 through the opening 27.

In the measuring station 25, there is an object 30 on the transport apparatus 24, which object is being measured by means of ultrasound. In the measuring station 25, two ultrasonic sensors 31 and 32 are provided for this purpose.

After the object 30 has been measured and the electrical signals have been sent to the artificial intelligence 29 by way of the at least one line 28, the object 30 is moved out of the measuring station 25 once again. In this regard, the object 30 leaves the measuring station 25 by way of an opening 33, which lies opposite the opening 27.

Because measuring of the objects as well as data processing take place very quickly, it is not necessary for the movement of the transport apparatus 24 in the direction of the arrow 26 to be interrupted, so that the transport of the objects through the measuring station 25 can take place continuously.

Although a different structure of the measuring station 25 is also conceivable, the measuring station 25 according to FIGS. 2 and 3 has a box-shaped structure, so that the measuring station 25 has a bottom 34, wherein the transport apparatus 24 is affixed and moved above the bottom 34. The bottom 34 is connected with a top 35 by way of side walls, wherein only the three side walls 36, 37, and 40 can be seen in FIG. 3. In this regard, it is possible that the top 35 is configured as a lid, wherein the lid 35 is removable, in order to carry out maintenance of the measuring station 25, if necessary, without the measuring station 25 having to be removed completely.

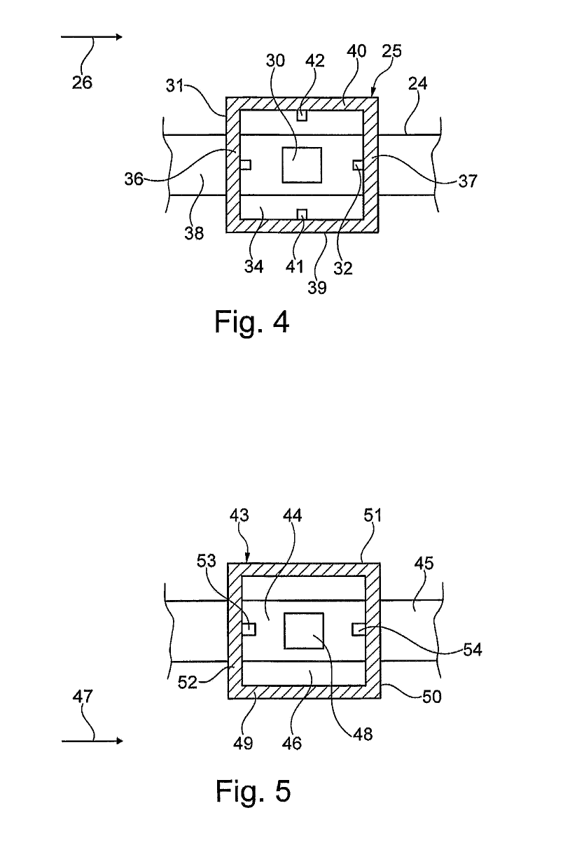

In FIG. 4, inner workings of the measuring station 25 shown in FIG. 2 are shown, wherein the top 35 was removed according to FIG. 3. In this way, the view is directly onto a top 38 of the transport apparatus 24 and thereby onto the bottom 34 of the measuring station 25. For the sake of clarity, only parts of the transport apparatus 24 are shown. The object 30 that is being measured by means of ultrasound is situated on this top 38 of the transport apparatus 24. For this purpose, the measuring station 25 has an ultrasonic sensor 31, 32, 41, 42 on each side wall 36, 37, 39, 40, in each instance. Each of these ultrasonic sensors 31, 32, 41, 42 emits ultrasonic waves, which are reflected by the object 30 and received by the transducers (which cannot be seen, because they are disposed in the ultrasonic sensors) disposed in the ultrasonic sensors 31, 32, 41, 42. The ultrasound recorded by the transducers is converted to electrical signals, which in turn are passed on to the artificial intelligence (cannot be seen in FIG. 4). In the artificial intelligence, finally, an image of the object 30 is produced from these electrical signals, wherein the image is compared with a reference image. By means of this comparison, it can be determined whether or not the object 30 is complete.

In FIG. 5, a variant of the measuring station shown in FIG. 4 is shown. In the case of the measuring station 43 shown in FIG. 5, the view is onto a top 44 of a transport apparatus 45, wherein the transport apparatus 45 is disposed above a bottom 46 of the measuring station 43, so that it can move. For the sake of clarity, once again only parts of the transport apparatus 45 are shown. This measuring station 43, too, has four side walls 49 to 52, as well as a top, which is disposed on the side walls 49 to 52, wherein the top in turn can be configured as a removable lid. Just like in the case of the measuring station according to FIG. 4, in the measuring station 43 according to FIG. 5 the top has also been removed and therefore cannot be seen. The transport apparatus 45 transports objects in the direction of an arrow 47 into the measuring station 43, and, after these objects have been measured, transports them out of this measuring station 43 once again. For this purpose, the measuring station 43 has two openings, as is also the case for the measuring station 25 according to FIGS. 2 to 4, but these openings cannot be seen in FIG. 5.

An object 48 is disposed on the top 44 of the transport apparatus 45, which object is situated in the measuring station 43 and is being measured by means of ultrasound. For this purpose, two ultrasonic sensors 53 and 54 are provided, which are affixed on two opposite side walls 50 and 52, respectively. Therefore the measuring station 25 of FIGS. 2 to 4 differs from the measuring station 43 of FIG. 5 only by the number of ultrasonic sensors.

Preferably, 2 to 10 and, particularly preferably, 2 to 4 ultrasonic sensors are provided in such a measuring station. By means of this number of ultrasonic sensors, a sufficiently precise image of an object can be obtained. In this regard, it is advantageous to provide more than one ultrasonic sensor, in particular if the object possesses a very complex structure.

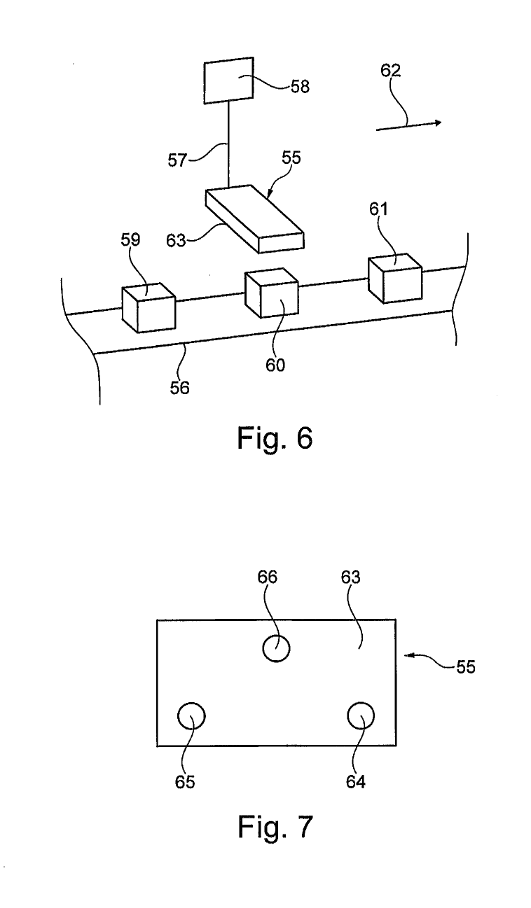

In FIG. 6, a further variant of a schematically shown measuring station 55 is shown, which is disposed above a transport apparatus 56. The measuring station 55 comprises three ultrasonic sensors, which are disposed on an underside 63 of the measuring station 55 and therefore cannot be seen. The measuring station 55 is connected with an artificial intelligence 58 by way of an electrical line 57. On the transport apparatus 56, only parts of which are shown, there are three objects 59, 60, 61, which are being moved in the direction of an arrow 62. The object 60, which is situated below the measuring station 55, is just being measured, whereas the object 61 has already been measured and is therefore being moved away from the measuring station 55. The measuring station 55 can be attached, by way of a holder, which is not shown in FIG. 6, however, for example to a ceiling of a building (not shown), in which the measuring station 55 is situated. An advantage of this measuring station 55 is that it can be serviced very easily. For example, this measuring station 55 can simply be removed when it needs to be serviced, and can be replaced by a different measuring station.

In FIG. 7, the underside 63 of the measuring station 55 is shown, so that the three ultrasonic sensors 64, 65 and 66 can be seen.

In FIGS. 1a to 6, the objects were shown only schematically. It is understood that any conceivable objects can be measured by means of ultrasound, by means of the method. Thus, for example, these objects can be beverage boxes that must be filled with a specific number of bottles, or, alternatively, circuit boards that must be equipped with a specific number of components.

For measurement of objects, it is sufficient if the measuring station has only one ultrasonic sensor. In the case of very complex objects or if a precise image must be obtained, it is a possibility to provide more than just one ultrasonic sensor. Thus, the measuring station can have 2 to 8, preferably 2 to 4 ultrasonic sensors, for example, if necessary.

Accordingly, although only a few embodiments of the present invention have been shown and described, it is to be understood that many changes and modifications may be made thereunto without departing from the spirit and scope of the invention.

What is claimed is:

1. A method for checking completeness of an object comprising:
(a) in a first step, passing a first object to a measuring station, wherein the measuring station has at least one ultrasonic sensor fixed in place;
(b) in a second step, measuring the first object using ultrasound, wherein signals are obtained and made available to an artificial intelligence, wherein the artificial intelligence, wherein the artificial intelligence creates an image of the object from the signals; and
(c) in a third step, comparing by the artificial intelligence the image obtained with a reference image derived from a predetermined, complete object.

2. The method according to claim 1, further comprising passing a second object to the measuring station after measuring the first object and repeating the steps (b) and (c).

3. The method according to claim 1, further comprising in a fourth step, sorting the object out if the image obtained does not agree with the reference image, or transporting the object to a further station if the image obtained does agree with the reference image.

4. The method according to claim 2, further comprising in a fourth step, sorting the object out if the image obtained does not agree with the reference image, or transporting the object to a further station if the image obtained does agree with the reference image.

5. The method according to claim 3, wherein the object not sorted out is packaged or processed further in the further station.

6. The method according to claim 4, wherein the object not sorted out is packaged or processed further in the further station.
